(19) United States
(12) Patent Application Publication
(10) Pub. No.: US 2011/0317766 A1
(43) Pub. Date: Dec. 29, 2011

(54) APPARATUS AND METHOD OF DEPTH CODING USING PREDICTION MODE

(75) Inventors: Il Soon LIM, Chungcheongnam-do (KR); Yo Sung Ho, Gwangju Metropolitan City (KR); Jae Joon Lee, Seoul (KR); Min Koo Kang, Changwon-si (KR)

(73) Assignees: GWANGJU INSTITUTE OF SCIENCE AND TECHNOLOGY, Gwangju Metropolitan City (KR); SAMSUNG ELECTRONICS CO., LTD., Suwon-si (KR)

(21) Appl. No.: 13/159,943

(22) Filed: Jun. 14, 2011

(30) Foreign Application Priority Data
Jun. 25, 2010 (KR) 10-2010-0060798

(51) Int. Cl. H04N 7/32; H04N 7/50

(52) U.S. Cl. 375/240.16; 375/E07.243; 375/E07.211

(57) ABSTRACT

A depth image coding method may calculate a depth offset of a depth image, may generate a prediction mode based on the depth offset, may minimize a prediction error of the depth image having a low correlation between adjacent points of view and a low temporal correlation and may enhance a compression rate. The depth offset may be calculated based on a representative value of adjacent pixels included in a template as opposed to using a depth representative value of pixels in a block and header information may not be needed to encode an offset and the offset may be generated by a depth image decoding apparatus. When a plurality of objects is included in a block, a depth offset is calculated for each of the plurality of objects and a motion vector is calculated for each of the plurality of objects and the depth image may be accurately predicted.

### CROSS-REFERENCE TO RELATED APPLICATIONS

This application claims the priority benefit of Korean Patent Application No. 10-2010-0060798, filed on Jun. 25, 2010, in the Korean Intellectual Property Office, the disclosure of which is incorporated herein by reference.

### BACKGROUND

1. Field

Example embodiments relate to a depth image coding apparatus and method using a prediction mode and a prediction mode generating apparatus and method, and more particularly, to a depth image coding apparatus and method using a prediction mode and a prediction mode generating apparatus and method that may generate the prediction mode.

2. Description of the Related Art

Recently, a three-dimensional (3D) video system includes depth data and a color image of at least two points of view. Accordingly, the 3D video system may need to effectively encode a quantity of input data and may need to perform coding both a multi-view color image and a multi-view depth image corresponding to the multi-view color image.

The multi-view video coding (MVC) standard has been developed to include various encoding schemes to satisfy demands for effective coding schemes with respect to a multi-view image. For example, the various encoding schemes may include an illumination charge-adaptive motion compensation (ICA MC) scheme that compensates for illumination based on a macro block (MB) unit during a motion estimation and motion compensation and a prediction structure for encoding a multi-view video.

Regarding the prediction structure for a multi-view video coding (MVC) scheme, an inter/intra prediction mode that effectively generates a prediction mode based on a spatio-temporal correlation of an image signal is used to effectively perform coding in H.264/AVC that is the latest video compression standard for a conventional single-view color image coding scheme. However, the MVC standard may need to use a prediction structure that more effectively encodes the multi-view image based on a correlation between points of view of images obtained by a multi-view camera, in addition to encoding the multi-view image based on a spatio-temporal correlation of a multi-view image signal.

The multi-view color image may be inconsistent between images even though careful attention is paid to an image obtaining process. The most frequent inconsistency is an illumination inconsistency between color images photographed in different points of view. A multi-view video is an image photographed by a plurality of cameras and illumination of images may be different from each other because of a change in a location of a camera, a difference in manufacturing process of cameras, and a difference in controlling an aperture, even though the same image is photographed. Therefore, the MVC standard of a moving picture experts group (MPEG) has provided an illumination compensation scheme.

A low temporal correlation of the depth image and a low correlation between points of view of the depth image may be caused by the depth estimation performed during a depth image generating process and by a motion generated by an object that is in the depth image and that moves in a depth direction. An object fixed in a location of the depth image always has the same depth value. When a depth image is generated based on a stereo matching scheme, a depth value of the fixed object may locally increase or decrease to a predetermined value, which is a main factor causing the low temporal correlation and the low correlation between points of view. When the object moves in the depth direction, a pixel value of the object that moves may linearly increase or decrease and thus, errors may frequently occur in prediction of images based on time. A decrease in coding efficiency may be enhanced by adding or subtracting a predetermined constant based on a macro block unit that performs motion estimation and compensation.

### SUMMARY

The foregoing and/or other aspects are achieved by providing a prediction mode generating method, the method including calculating, by at least one processor, a first depth representative value indicating a depth representative value of a current block of a depth image, and a second depth representative value indicating a depth representative value of a reference block corresponding to the current block, calculating, by the at least one processor, a depth offset based on the first representative value and the second depth representative value, calculating, by the at least one processor, a motion vector by predicting motion based on a change in a depth of the current block and a change in a depth of the reference block, and generating, by the at least one processor, a prediction mode having a compensated depth value, based on the depth offset, the motion vector, and reference image information associated with the reference block.

The foregoing and/or other aspects are achieved by providing a prediction mode generating apparatus, the apparatus including a depth offset calculator to calculate a first depth representative value indicating a depth representative value of a current block of a depth image, to calculate a second depth representative value indicating a depth representative value of a reference block corresponding to the current block, and to calculate a depth offset based on the first depth representative value and the second depth representative value, a motion vector calculator to calculate a motion vector by predicting motion based on a change in a depth of the current block and a change in a depth of the reference block, and a prediction mode generating unit to generate a prediction mode having a compensated depth value, based on the depth offset, the motion vector, and reference image information associated with the reference block.

The foregoing and/or other aspects are achieved by providing a depth image coding apparatus that encodes a depth image based on a prediction mode, the apparatus including a first generating unit to generate a prediction mode having a compensated depth value with respect to a current block of a depth image, when the depth image is input, a second generating unit to generate a residual block by subtracting the prediction mode from the current block, a quantizing unit to transform and quantize the residual block, and a coding unit to encode the quantized residual block to generate a bitstream.

The foregoing and/or other aspects are achieved by providing a depth image decoding apparatus that decodes a depth image, the apparatus including a decoding unit to decode a bit stream of the depth image, to extract a residual block and reference image information when the bit stream is input, a dequantizing unit to dequantize and inverse transform the residual block, a depth offset calculator to calculate a depth offset corresponding to the depth image, a prediction mode generating unit to generate an intermediate prediction mode by applying, based on the reference image information, the motion vector to the reference block, and to generate a prediction mode having a compensated depth value by adding the depth offset to the prediction mode, and restoring unit to restore a current block by adding the residual block to the prediction mode.

The foregoing and/or other aspects are achieved by providing a method, including generating, by at least one processor, a prediction mode to encode a multi-view image based on temporal correlation of images of an object, the generating including calculating a first depth representative value of a current block of a depth image and a second depth representative value of a reference block of the depth image, calculating, by the at least one processor, a difference between the first depth representative value and the second depth representative value, calculating, by the at least one processor, a change in a depth value of the object based on the difference and determining, by the at least one processor, the prediction mode based on the change in the depth value to improve the temporal correlation.

According to another aspect of one or more embodiments, there is provided at least one non-transitory computer readable medium including computer readable instructions that control at least one processor to implement methods of one or more embodiments.

Additional aspects, features and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of embodiments, taken in conjunction with the accompanying drawings of which:

FIG. 1 illustrates a configuration of a prediction mode generating apparatus according to example embodiments.

FIG. 2 illustrates a configuration of a depth image coding apparatus where a prediction mode generating apparatus is inserted as a module according to example embodiments.

FIG. 3 illustrates a frame and a block with respect to a depth image according to example embodiments.

FIG. 4 illustrates a template according to example embodiments.

FIG. 5 illustrates a configuration of a depth image decoding apparatus that decodes a depth image according to example embodiments.

FIG. 6 is a flowchart illustrating a prediction mode generating method according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

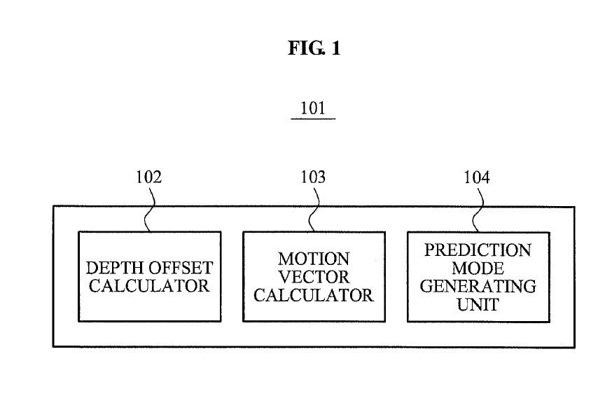

FIG. 1 illustrates an example of a prediction mode generating apparatus.

Referring to FIG. 1, a prediction mode generating apparatus 101 that generates a prediction mode having a compensated depth value may include a depth offset calculator 102, a motion vector calculator 103, and a prediction mode generating unit 104.

A depth image may be an image where information associated with a depth, i.e., a distance, between an object in a three-dimensional (3D) video and a camera is expressed as a two-dimensional (2D) video format.

According to example embodiments, depth information of the depth image may be transformed to a depth value based on Equation 1.

$$Z = {Z}_{far} + v \cdot \frac{{Z}_{near} - {Z}_{far}}{255} with v ∈ [ 0 , … , 255 ] \qquad [ Equation 1 ]$$

In Equation 1, Zₙₑₐᵣ may denote a distance between a camera and an object that is nearest to the camera from among at least one object in an image. Z_{far} may denote a distance between the camera and an object that is farthest from the camera from among the at least one object in the image. Z may denote a distance between the camera and the actual object, as opposed to a distance or a depth, in the image. Z may be expressed by an integer between zero and 255.

Accordingly, the depth value v indicating the depth, i.e. the distance, in the depth image may be calculated based on Equation 1.

According to example embodiments, the depth image may be divided into blocks of a predetermined size and may be encoded or decoded.

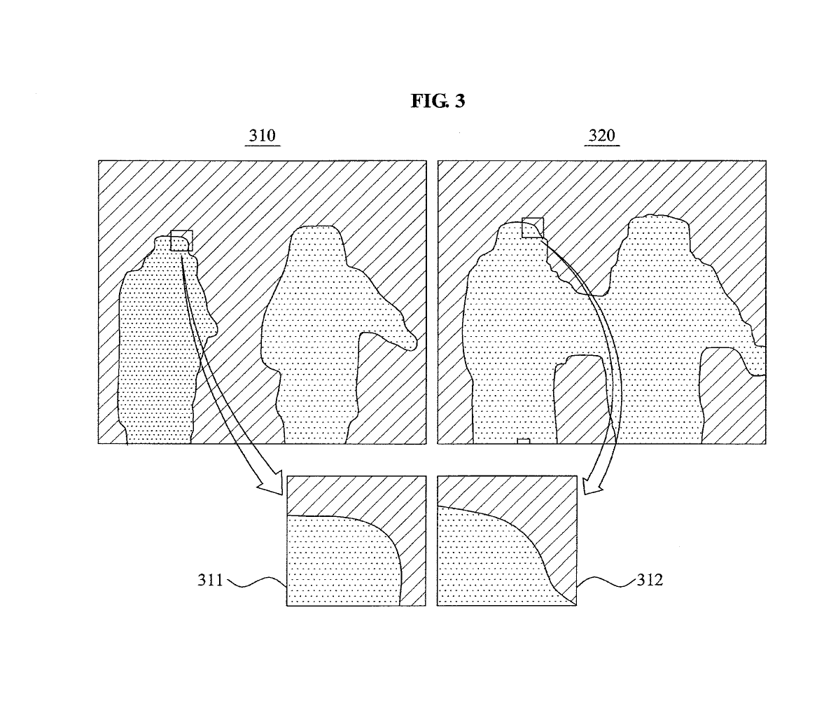

A block is described with reference to FIG. 3.

FIG. 3 illustrates an example of a frame and a block with respect to a depth image.

Referring to FIG. 3, the depth image may include a plurality of frames, such as a reference frame 310 and a current frame 320. In this example, the reference frame 310 may be directly encoded, and a depth image coding apparatus and a depth image decoding apparatus may refer to the encoded reference frame. The reference frame 310 may be divided into blocks of a predetermined size and may be encoded. In this example, a reference block 311 may be one of the blocks in the reference frame 310.

The current frame 320 may not be directly encoded, and may be restored from the reference frame 310 in the depth image decoding apparatus. The current frame 320 may be divided into blocks of a predetermined size, and a current block 312 may be one of the blocks in the current frame 320.

According to example embodiments the reference frame 310 may be a frame having the same point of view as the current frame 320 and having a different time slot from the current frame 320. The reference frame 310 may also be a frame having a different point of view from the current frame 320 and having the same time slot as the current frame 320.

Referring again to FIG. 1, the depth offset calculator 102 may calculate a first depth representative value indicating a depth representative value of a current block of the depth image and may calculate a second depth representative value indicating a depth representative value of a reference block corresponding to the current block.

A depth representative value may be one of a mean value and a median value of depth values of a plurality of pixels included in a block.

According to example embodiments, the depth offset calculator 120 may calculate the depth representative value based on a template.

The template may be located within a range of a reference value from the block, and may include adjacent pixels.

The adjacent pixels may be encoded, and the depth image coding apparatus and the depth image decoding apparatus may refer to the encoded adjacent pixels.

According to example embodiments, the depth offset calculator 102 may calculate the depth representative value based on pixel values of the adjacent pixels included in the template.

According to example embodiments, the depth offset calculator 102 may calculate the depth representative value based on one of at least one previously generated template. The depth offset calculator 102 may select one of the at least one previously generated template, and may calculate the depth representative value based on pixel values of adjacent pixels included in the selected template.

According to example embodiments, the depth offset calculator 102 may generate a template. The depth offset calculator 102 may calculate the depth representative value based on pixel values of adjacent pixels included in the generated template.

The depth representative value may be one of a mean value and a median value of depth values of the adjacent values.

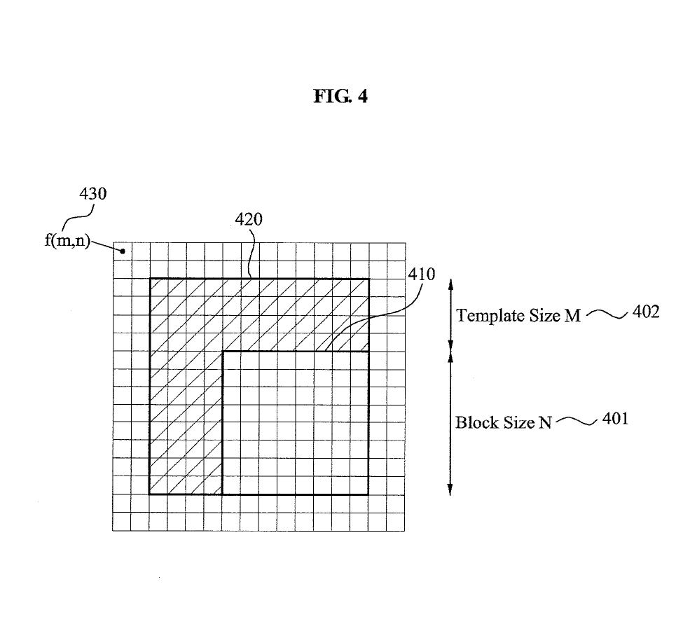

The template is described with reference to FIG. 4.

FIG. 4 illustrates an example of a template 420.

Referring to FIG. 4, the template 420 may be located within a range of a reference value from a block 410 which indicates a current block or a reference block, and the reference value may be a variable M 402 which indicates a size of the template.

The template 420 may be in a shape of ‘┌’, and the shape of the template 420 may not be limited to any predetermined shape. The shape of the template 420 and a number of adjacent pixels included in the template may be determined based on a size of the block 410, a number of objects included in the block 410, a shape of the objects included in the template, and the like.

In this example, the template 420 may include adjacent pixels indicating pixels that are directly encoded, and a depth image coding apparatus and a depth image decoding apparatus may directly refer to the encoded adjacent pixels.

The depth offset calculator 102 may determine, as a depth representative value with respect to the block 410, one of a mean value and a median value of depth values of pixels included in the block 410.

Referring to FIG. 1, the depth offset calculator 102 may determine, as a depth representative value with respect to the block 410, one of a mean value and a median value of depth values of adjacent pixels included in the template 420, as opposed to the mean value or the median value of the depth values with respect to the pixels included in the block 410. Regarding a depth image, a texture is not included, and pixels included in the same object in the image have the similar depth values. Thus, a mean value or a median value of the depth values of the adjacent pixels in the template 420 adjacent to the block 410 may be determined as the depth representative value of the block 410.

Therefore, when the block 410 is the current block, a depth representative value M_{CT} of the current block which is based on the depth values of the adjacent pixels included in the template 420 may be calculated based on Equation 2.

$${M}_{CT} ( m , n ) = \frac{1}{NPT} [ {\sum }_{i - m}^{m + M + N - 1} {\sum }_{j - n}^{n + M - 1} f ( i , j ) + {\sum }_{i - m}^{m + M - 1} {\sum }_{j - n + M}^{n + M + N - 1} f ( i , j ) ] \qquad [ Equation 2 ]$$

In Equation 2, the variable M 402 may denote a size of the template 420, the variable N 401 may denote a size of the block 410, (m, n) may denote coordinates of a pixel located in a top left side, and f(m, n) may denote a depth value of a pixel located in (m, n). A number of pixels in the template (NPT) may denote 2×N×M+M².

When the block 410 is a reference block, a depth representative value M_{RT} of the reference block which is based on depth values of adjacent pixels included in the template 420 may be calculated based on Equation 3.

$${M}_{RT} ( p , q ) = \frac{1}{NPT} [ {\sum }_{i - p}^{p + M + N - 1} {\sum }_{j - q}^{q + M - 1} r ( i , j ) + {\sum }_{i - p}^{p + M - 1} {\sum }_{j - q + M}^{q + M + N - 1} r ( i , j ) ] \qquad [ Equation 3 ]$$

Referring again to FIG. 1, the depth offset calculator 102 may calculate a depth offset based on the first depth representative value and the second depth representative value.

The depth offset may denote a value to be used for an offset process when a prediction mode of the depth image is generated.

According to example embodiments, the depth offset calculator 102 may calculate a depth offset by subtracting a depth representative value of the reference block from a depth representative value of the current block. The depth offset calculator 102 may calculate the depth offset by subtracting the depth representative value M_{RT} of Equation 3 from the depth representative value M_{CT} of Equation 2.

The motion vector calculator 103 may calculate a motion vector by estimating a motion based on a change in a depth of the current block and a change in a depth of the reference block.

The motion vector calculator 103 may calculate the motion vector based on depth values of the current block and depth values of the reference block.

According to example embodiments, the motion vector calculator 103 may generate a first difference block by subtracting the depth representative value of the current block from the current block, may generate a second difference block by subtracting the depth representative value of the reference block from the reference block, and may calculate the motion vector based on the first difference block and the second difference block.

When a plurality of reference blocks exist, the motion vector calculator 103 may calculate a mean-removed sum of absolute differences (SAD) (MR_SAD) based on Equation 4, may select a difference block with reference to a reference block having a minimal MR_SAD, and may calculate a motion vector based on the selected difference block. MR_SAD may denote a SAD between the first difference block and the second difference block.

$$MR\_SAD ( x , y ) = {\sum }_{i = m}^{m + S - 1} {\sum }_{j = n}^{n + T - 1} \vert \{ f ( i , j ) - {M}_{CT} \} - \{ r ( i + x , j + y ) - {M}_{RT} \} \vert \qquad [ Equation 4 ]$$

The prediction mode generating unit 104 may generate a prediction mode having compensated depth value, based on the depth offset, the motion vector, and reference image information associated with the reference block.

The reference image information may include an identification (ID) of a reference frame corresponding to the reference block, information associated with a time, information associated with a point of view, and the like.

According to example embodiments, the prediction mode generating unit 104 may generate an intermediate prediction mode by applying the motion vector to the reference block based on the reference image information. The prediction mode generating unit 104 may generate the prediction mode having a compensated depth value by adding the depth offset to the intermediate prediction mode.

According to example embodiments, a plurality of objects may be included in a block. For example, two objects, such as a human and a background, may be included in each of the reference block 311 and the current block 312 of FIG. 3.

According to example embodiments, when a plurality of objects is included in a block, the prediction mode generating apparatus 101 may classify the plurality of objects by comparing the objects with a threshold.

The prediction mode generating apparatus 101 may determine, as the threshold, a median value between a maximal value and a minimal value of depth values of pixels in a block, may classify an object corresponding to pixels having a value greater than the threshold as a foreground, and may classify an object corresponding to pixels having a value less than the threshold as a background.

When the plurality of objects is included in a block, the depth offset calculator 102 may calculate a depth representative value for each of the plurality of objects. The depth offset calculator 102 may calculate a depth offset for each of the plurality of objects. The motion vector calculator 103 may calculate a motion vector for each of the plurality of objects.

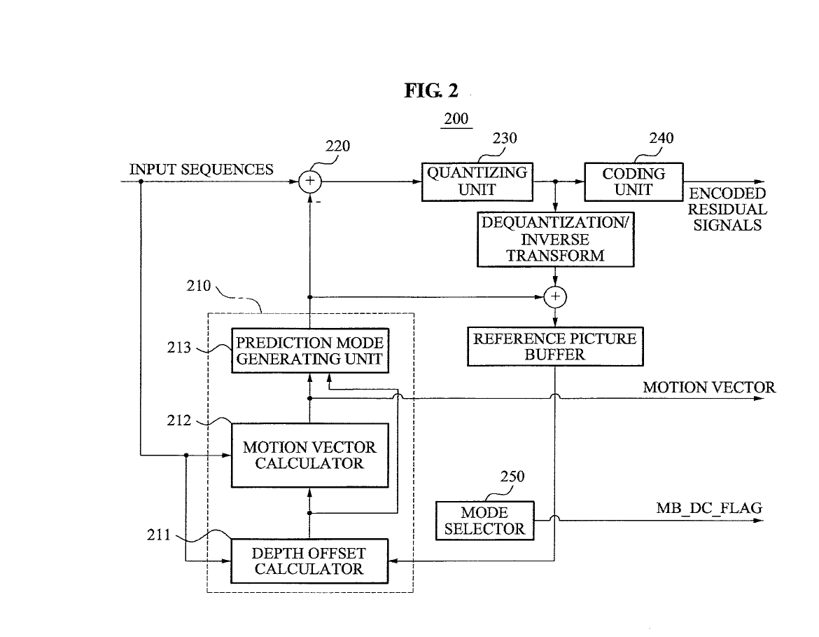

FIG. 2 illustrates a configuration of a depth image coding apparatus having a prediction mode generating apparatus according to example embodiments.

Referring to FIG. 2, the depth image coding apparatus 200 that encodes a depth image based on a prediction mode may include a first generating unit 210, a second generating unit 220, a quantizing unit 230, and a coding unit 240.

When a depth image is input, the first generating unit 210 may generate a prediction mode having a compensated depth value of a current block of the input depth image.

The first generating unit 210 may have the prediction mode generating apparatus.

Accordingly, the first generating unit 210 may include a depth offset calculator 211, a motion vector calculator 212, and a prediction mode generating unit 113. The depth offset calculator 211, the motion vector calculator 212, and the prediction mode generating unit 113 included in the first generating unit 210 may correspond to the depth offset calculator 102, the motion vector calculator 103, and the prediction mode generating unit 104, respectively.

A process that generates a prediction mode in the first generating unit 110 has been described with reference to FIG. 1 and thus, detailed descriptions thereof are omitted herein.

The second generating unit 220 may generate a residual block by subtracting the prediction mode from the current block.

The quantizing unit 230 may transform and quantize the residual block.

The coding unit 240 may encode the quantized residual block to generate a bitstream.

According to example embodiments, the depth image coding apparatus 200 may further include a mode selector 250. The mode selector 250 may select a prediction to be used when the depth image coding apparatus 200 encodes the depth image which has the compensated depth value and that is generated by the first generating unit 210 as well as a prediction mode generated based on another prediction mode generating scheme. The mode selector 250 may output information associated with the selected prediction mode. For example, the mode selector 250 may output the information by inputting the information to MB_DC_FLAG.

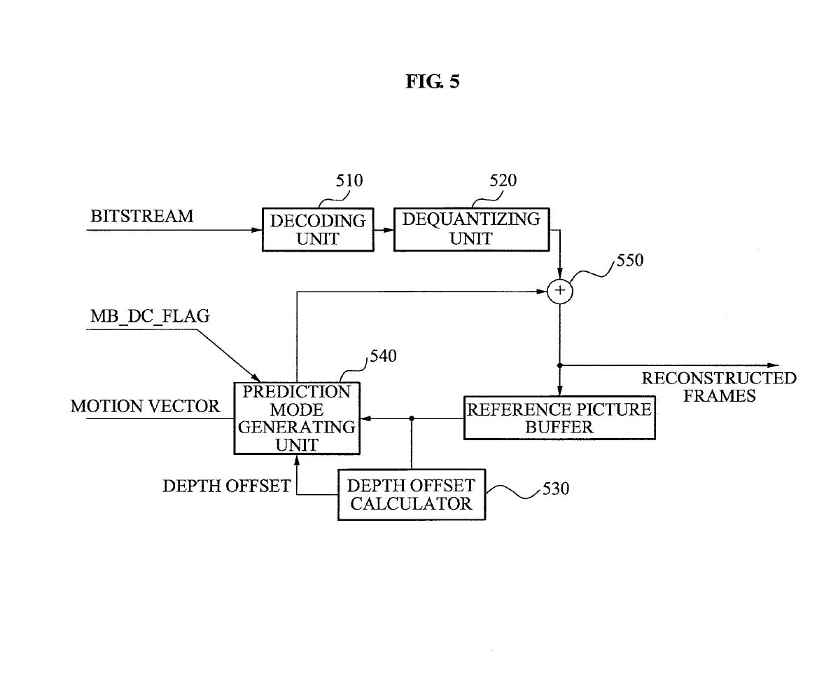

FIG. 5 illustrates a configuration of a depth image decoding apparatus that decodes a depth image according to example embodiments.

Referring to FIG. 5, the depth image decoding apparatus that decodes the depth image may include a decoding unit 510, a dequantizing unit 520, a depth offset calculator 530, a prediction mode generating unit 540, and a restoring unit 550.

When a bitstream of the depth image is input, the decoding unit 510 may decode the inputted bitstream to extract a residual block and reference image information.

The dequantizing unit 520 may dequantize and inverse transform the residual block.

The depth offset calculator 530 may calculate a depth offset corresponding to the depth image. A process that calculates the depth offset has been described with reference to FIG. 1 and detailed descriptions thereof are omitted herein.

The prediction mode generating unit 540 may generate an intermediate prediction mode by applying a motion vector to a reference block based on the reference image information. The prediction mode generating unit 540 may generate a prediction mode having a compensated depth value by adding the depth offset to the intermediate prediction mode.

The restoring unit 550 may restore a current block by adding a residual block to the prediction mode.

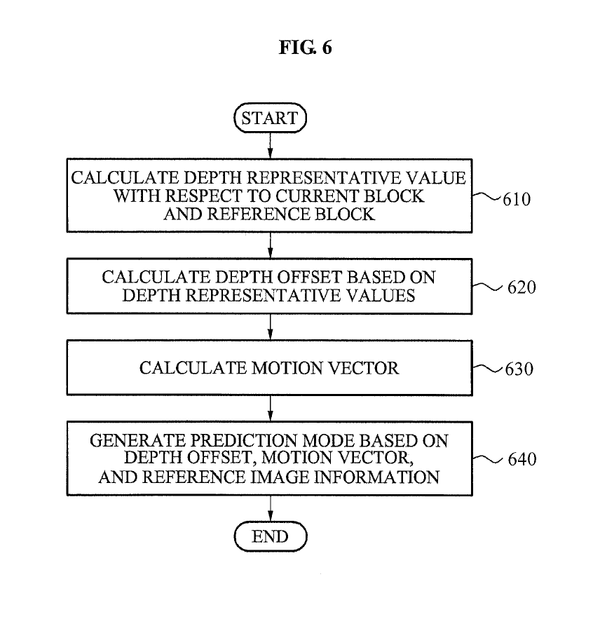

FIG. 6 illustrates a prediction mode generating method according to example embodiments.

Referring to FIG. 6, the prediction mode generating method may calculate a first depth representative value indicating a depth representative value of a current block of a depth image and a second depth representative value indicating a depth representative value of a reference block corresponding to the current block in 610.

The depth representative value may be one of a mean value and a median value of depth values of a plurality of pixels included in a block.

The prediction mode generating method may calculate a depth representative value based on a template.

The template may be located within a range of a reference value from the block and may include adjacent pixels.

The adjacent pixels may be encoded and a depth image coding apparatus and a depth image decoding apparatus may refer to the encoded adjacent pixels.

The prediction mode generating method may calculate the depth representative value based on pixel values of the adjacent pixels included in the template.

According to example embodiments, the prediction mode generating method may calculate the depth representative value based on one of at least one previously generated template. The prediction mode generating method may select one of the at least one previously generated template, and may calculate the depth representative value based on pixel values of adjacent pixels included in the selected template.

According to example embodiments, the prediction mode may generate a template. The prediction mode generating method may calculate the depth representative value based on pixel values of adjacent pixels included in the generated template.

The depth representative value may be one of a mean value and a median value of depth values of the adjacent pixels.

The prediction mode generating method may calculate a depth offset based on the first depth representative value and the second depth representative value in 620.

The depth offset may denote a value to be used for an offset process when a prediction mode of the depth image is generated.

According to example embodiments, the prediction mode generating method may calculate the depth offset by subtracting a depth representative value of a reference block from a depth representative value of a current block. The prediction mode generating method may calculate the depth offset by subtracting a depth representative value M_{RT} of Equation 3 from a depth representative value M_{CT} of Equation 2.

The prediction mode generating method may calculate a motion vector by estimating a motion based on a change in a depth of the current block and a change in a depth of the reference block in 630.

The prediction mode generating method may calculate the motion vector based on a depth value of the current block and a depth value of the reference block.

According to example embodiments, the prediction mode generating method may generate a first difference block by subtracting the depth representative value of the current block from the current block, may generate a second difference block by subtracting the depth representative value of the reference block from the reference block, and may calculate the motion vector based on the first difference block and the second difference block.

When a plurality of reference blocks exists, the prediction mode generating method may calculate a MR_SAD to select a difference block of a reference block having a minimal MR_SAD, and may calculate the motion vector based on the selected difference block.

The prediction mode generating method may generate a prediction mode having a compensated depth value, based on the depth offset, the motion vector, and reference image information associated with the reference block in 640.

The reference image information may include an ID of a reference frame corresponding to the reference block, information associated with a time, information associated with a point of view, and the like.

According to example embodiments, the prediction mode generating method may generate an intermediate prediction mode by applying the motion vector to the reference block based on the reference image information. The prediction mode generating method may generate the prediction mode having the compensated depth value by adding the depth offset to the intermediate prediction mode.

According to example embodiments, a plurality of objects may be included in a block. For example, two objects, such as a human and a background, may be included in each of the reference block 311 and the current block 312 as shown in FIG. 3.

According to example embodiments, the prediction mode generating method may classify the plurality of objects by a comparison with a threshold when the plurality of objects is included in the block.

The prediction mode generating method may determine, as the threshold, a median value between a maximal value and a minimal value of depth values of pixels in the block, may classify an object corresponding to pixels having a value greater than the threshold as a foreground, and may classify an object corresponding to pixels having a value less than the threshold as a background.

When the plurality of objects is included in the block, the prediction mode generating method may calculate a depth representative value for each of the plurality of objects. The prediction mode generating method may calculate a depth offset for each of the plurality of objects. The prediction mode generating method may calculate a motion vector for each of the plurality of objects.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may be a plurality of computer-readable storage devices in a distributed network, so that the program instructions are stored in the plurality of computer-readable storage devices and executed in a distributed fashion. The program instructions may be executed by one or more processors or processing devices. The computer-readable media may also be embodied in at least one application specific integrated circuit (ASIC) or Field Programmable Gate Array (FPGA). Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it should be appreciated by those skilled in the art that changes may be made in these embodiments without departing from the principles and spirit of the disclosure, the scope of which is defined by the claims and their equivalents.

1. A method of generating a prediction mode, the method comprising:
calculating, by at least one processor, a first depth representative value indicating a depth representative value of a current block of a depth image, and a second depth representative value indicating a depth representative value of a reference block corresponding to the current block;
calculating, by the at least one processor, a depth offset based on the first representative value and the second depth representative value;
calculating, by the at least one processor, a motion vector by predicting motion based on a change in a depth of the current block and a change in a depth of the reference block; and
generating, by the at least one processor, a prediction mode having a compensated depth value, based on the depth offset, the motion vector, and reference image information associated with the reference block.

2. The method of claim 1, wherein the generating of the prediction mode comprises:
generating an intermediate prediction mode by applying the motion vector to the reference block based on the reference image information; and
generating the prediction mode having the compensated depth value by adding the depth offset to the intermediate prediction mode.

3. The method of claim 1, wherein the calculating of the first depth representative value and the second depth representative value comprises:
calculating a corresponding depth representative value based on pixel values of adjacent pixels included in a template.

4. The method of claim 3, wherein:
the template is located within a range of a reference value from the corresponding block; and
the adjacent pixels are encoded, and a depth image coding apparatus and a depth image decoding apparatus refer to the encoded adjacent pixels.

5. The method of claim 3, further comprising:
generating the template.

6. The method of claim 1, wherein a corresponding depth representative value is one of a mean value of depth values of a plurality of pixels in a corresponding block and a median value of the depth values of the plurality of pixels in the corresponding block.

7. The method of claim 3, wherein the corresponding depth representative value is one of a mean value of depth values of the adjacent pixels and a median value of the depth values of the adjacent pixels.

8. The method of claim 1, wherein the calculating of the motion vector comprises:
generating a first difference block by subtracting the first depth representative value from the current block;
generating a second difference block by subtracting the second depth representative value from the reference block; and
calculating the motion vector based on the first difference block and the second difference block.

9. The method of claim 1, further comprising:
classifying a plurality of objects by comparing the plurality of objects with a threshold when the plurality of objects is included in a corresponding block,
wherein:
the calculating of a corresponding depth representative value comprises calculating a corresponding depth representative value with respect to each of the multiple objects;
the calculating of the depth offset comprises calculating the depth offset with respect to each of the plurality of objects; and
the calculating of the motion vector comprises calculating the motion vector with respect to each of the plurality of objects.

10. At least one non-transitory computer-readable medium comprising computer readable instructions that control at least one processor to perform the method of claim 1.

11. An apparatus generating a prediction mode, the apparatus comprising:
a depth offset calculator to calculate a first depth representative value indicating a depth representative value of a current block of a depth image, to calculate a second depth representative value indicating a depth representative value of a reference block corresponding to the current block, and to calculate a depth offset based on the first depth representative value and the second depth representative value;
a motion vector calculator to calculate a motion vector by predicting motion based on a change in a depth of the current block and a change in a depth of the reference block; and
a prediction mode generating unit to generate a prediction mode having a compensated depth value, based on the depth offset, the motion vector, and reference image information associated with the reference block.

12. An apparatus encoding a depth image based on a prediction mode, the apparatus comprising:
a first generating unit to generate a prediction mode having a compensated depth value with respect to a current block of a depth image when the depth image is input;
a second generating unit to generate a residual block by subtracting the prediction mode from the current block;
a quantizing unit to transform and quantize the residual block; and
a coding unit to encode the quantized residual block to generate a bitstream.

13. The apparatus of claim 12, wherein the first generating unit comprises:
a depth offset calculator to calculate a first depth representative value indicating a depth representative value of a current block of the depth image, to calculate a second depth representative value indicating a depth representative value of a reference block corresponding to the current block, and to calculate a depth offset by subtracting the second depth representative value from the first depth representative value;
a motion vector calculator to calculate a motion vector by predicting a motion based on a change in a depth of the current block and a change in a depth of the reference block; and
a prediction mode generating unit to generate a prediction mode having a compensated depth value, based on the depth offset, the motion vector, and reference image information associated with the reference block.

14. An apparatus decoding a depth image, the apparatus comprising:
a decoding unit to decode a bit stream with respect to the depth image, to extract a residual block and reference image information when the bit stream is input;
a dequantizing unit to dequantize and inverse transform the residual block;
a depth offset calculator to calculate a depth offset corresponding to the depth image;
a prediction mode generating unit to generate an intermediate prediction mode by applying, based on the reference image information, the motion vector to the reference block, and to generate a prediction mode having a compensated depth value by adding the depth offset to the prediction mode; and
a restoring unit to restore a current block by adding the residual block to the prediction mode.

15. A method, comprising,
generating, by at least one processor, a prediction mode to encode a multi-view image based on temporal correlation of images of an object, the generating including calculating a first depth representative value of a current block of a depth image and a second depth representative value of a reference block of the depth image;
calculating, by the at least one processor, a difference between the first depth representative value and the second depth representative value;
calculating, by the at least one processor, a change in a depth value of the object based on the difference; and
determining, by the at least one processor, the prediction mode based on the change in the depth value to improve the temporal correlation.

16. At least one non-transitory computer-readable medium comprising computer readable instructions that control at least one processor to perform the method of claim 15.

17. The method of claim 15, wherein the change in the depth value of the object is caused by movement of the object in a depth direction.

18. The method of claim 17, wherein illumination inconsistencies between the images of the object caused by the movement of the object in the depth direction are corrected.
